(19) United States
(12) Patent Application Publication
(10) Pub. No.: US 2017/0308840 A1
(43) Pub. Date: Oct. 26, 2017

(54) RULE-BASED OPTIMIZATION OF TERRITORY PLANNING

(71) Applicant: LinkedIn Corporation, Mountain View, CA (US)

(72) Inventors: Huan V. Hoang, San Jose, CA (US); Juan Wang, Los Altos, CA (US); Zhaoying Han, Mountain View, CA (US); Chung-Ting John Chao, Foster City, CA (US); Wei Di, Cupertino, CA (US); Qiang Zhu, Sunnyvale, CA (US); Sui Yan, Sunnyvale, CA (US); Xing Zhou, Mountain View, CA (US)

(73) Assignee: LinkedIn Corporation, Mountain View, CA (US)

(21) Appl. No.: 15/134,250

(22) Filed: Apr. 20, 2016

(51) Int. Cl. G06Q 10/06

(52) U.S. Cl. CPC G06Q 10/063112; G06Q 10/06311

(57) ABSTRACT

The disclosed embodiments provide a system for processing data. During operation, the system obtains a first set of rules for assigning a first set of sales professionals to a first set of accounts, wherein the first set of rules comprises a representative load rule, a matching rule, and a balancing rule. Next, the system applies an optimization technique to the first set of rules and a first set of parameters associated with the first set of sales professionals and the first set of accounts to produce a first set of assignments of the first set of sales professionals to the first set of accounts. The system then outputs the first set of assignments for using in managing sales activity of the first set of sales professionals.

### RELATED APPLICATION

The subject matter of this application is related to the subject matter in a co-pending non-provisional application by inventors John Chao, Liangie Hue, Huan Hoang, Wenjing Zhang, Michael Miller, Josh VanGeest and Qiang Zhu, entitled “Assigning Target Entities to Members of a Group Based on Social Proximity,” having Ser. No. 14/722,150, and filing date 27 May 2015 (Attorney Docket No. 60352-0079).

### BACKGROUND

### Field

The disclosed embodiments relate to techniques for managing sales activities. More specifically, the disclosed embodiments relate to techniques for performing rule-based optimization of territory planning for sales professionals.

### Related Art

Social networks may include nodes representing entities such as individuals and/or organizations, along with links between pairs of nodes that represent different types and/or levels of social familiarity between the nodes. For example, two nodes in a social network may be connected as friends, acquaintances, family members, and/or professional contacts. Social networks may further be tracked and/or maintained on web-based social networking services, such as online professional networks that allow the entities to establish and maintain professional connections, list work and community experience, endorse and/or recommend one another, run advertising and marketing campaigns, promote products and/or services, and/or search and apply for jobs.

In turn, social networks and/or online professional networks may facilitate sales and marketing activities and operations by the entities within the networks. For example, sales professionals may use an online professional network to identify prospective customers, maintain professional images, establish and maintain relationships, and/or close sales deals. Moreover, the sales professionals may produce higher customer retention, revenue, and/or sales growth by leveraging social networking features during sales activities. For example, a sales representative may improve customer retention by tailoring his/her interaction with a customer to the customer's behavior, priorities, needs, and/or market segment, as identified based on the customer's activity and profile on an online professional network.

Consequently, the performance of sales professionals may be improved by using social network data to develop and implement sales strategies.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

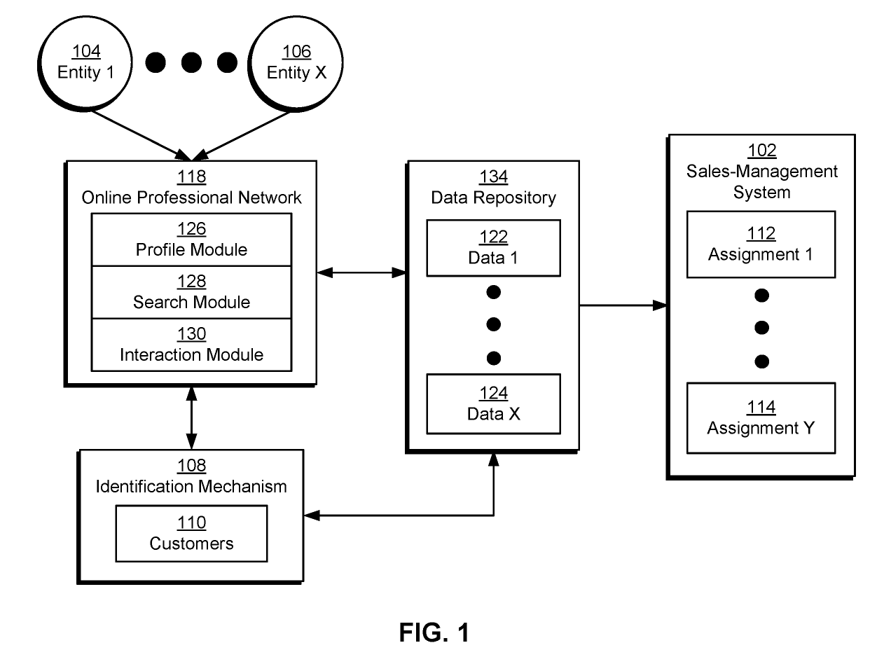

The disclosed embodiments provide a method, apparatus, and system for processing data. More specifically, the disclosed embodiments provide a method, apparatus, and system for performing rule-based optimization of territory planning for sales professionals. As shown in FIG. 1, the sales professionals may operate within the context of a social network, such as an online professional network 118 that allows a set of entities (e.g., entity 1 104, entity x 106) to interact with one another in a professional and/or business context.

The entities may include users that use online professional network 118 to establish and maintain professional connections, list work and community experience, endorse and/or recommend one another, and/or search and apply for jobs. The entities may also include companies, employers, and/or recruiters that use online professional network 118 to list jobs, search for potential candidates, and/or provide business-related updates to users.

The entities may use a profile module 126 in online professional network 118 to create and edit profiles containing profile pictures, along with information related to the entities' professional and/or industry backgrounds, experiences, summaries, projects, and/or skills. Profile module 126 may also allow the entities to view the profiles of other entities in online professional network 118.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on online professional network 118 to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or newsfeed that provides the latest postings, articles, and/or updates from the entities' connections and/or groups to the entities. Similarly, online professional network 118 may include mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in online professional network 118 may be tracked and stored in a database, data warehouse, cloud storage, and/or other data-storage mechanism providing data repository 134.

The entities may also include a set of customers 110 that purchase products through online professional network 118. For example, customers 110 may include individuals and/or organizations with profiles on online professional network 118 and/or sales accounts with sales professionals that operate through online professional network 118. As a result, customers 110 may use online professional network 118 to interact with professional connections, list and apply for jobs, establish professional brands, purchase or use products offered through online professional network 118, and/or conduct other activities in a professional and/or business context.

Customers 110 may also be targeted for marketing or sales activities by other entities in online professional network 118. For example, customers 110 may be companies that purchase business products and/or solutions that are offered by online professional network 118 to achieve goals related to hiring, marketing, advertising, and/or selling. In another example, customers 110 may be individuals and/or companies that are targeted by marketing and/or sales professionals through online professional network 118.

As shown in FIG. 1, customers 110 may be identified by an identification mechanism 108 using data from data repository 134 and/or online professional network 118. For example, identification mechanism 108 may identify customers 110 by matching profile data, group memberships, industries, skills, customer relationship data, and/or other data for customers 110 to keywords related to products that may be of interest to customers 110. Identification mechanism 108 may also identify, as customers 110, individuals and/or companies that have sales accounts with online professional network 118 and/or products offered by or through online professional network 118. As a result, customers 110 may include entities that have purchased products through and/or within online professional network 118, as well as entities that have not yet purchased but may be interested in products offered through and/or within online professional network 118.

Identification mechanism 108 may also match customers 110 to products using different sets of criteria. For example, identification mechanism 108 may match customers in recruiting roles to recruiting solutions, customers in sales roles to sales solutions, customers in marketing roles to marketing solutions, and customers in advertising roles to advertising solutions. If different variations of a solution are available, identification mechanism 108 may also identify the variation that may be most relevant to the customer based on the size, location, industry, and/or other attributes of the customer. In another example, products offered by other entities through online professional network 118 may be matched to current and/or prospective customers through criteria specified by the other entities. In a third example, customers 110 may include some or all entities in online professional network 118, which may be targeted with products such as “premium” subscriptions or memberships with online professional network 118.

After customers 110 are identified, they may be targeted by one or more sales professionals with relevant products. For example, the sales professionals may engage customers 110 with recruiting, marketing, sales, and/or advertising solutions that may be of interest to the customers. After a sales deal is closed with a given customer, a sales professional may follow up with the customer to improve the customer lifetime value (CLV) and retention of the customer.

To facilitate prioritization of sales activities with the customers, a sales-management system 102 may automatically generate a set of assignments (e.g., assignment 1 112, assignment y 114) of sales professionals to customers 110 for use in subsequent targeting of the customers by the sales professionals. For example, sales-management system 102 may assign sets of sales accounts associated with online professional network 110 to groups of sales professionals that operate through and/or are otherwise associated with or identified using online professional network 118. As described in further detail below, sales-management system 102 may use an optimization technique that balances one or more metrics among a set of sales professionals while adhering to a number of constraints associated with the sales professionals and/or accounts. As a result, sales-management system 102 may generate the assignments more efficiently and effectively than conventional territory planning techniques that manually assign sales professionals to sales accounts.

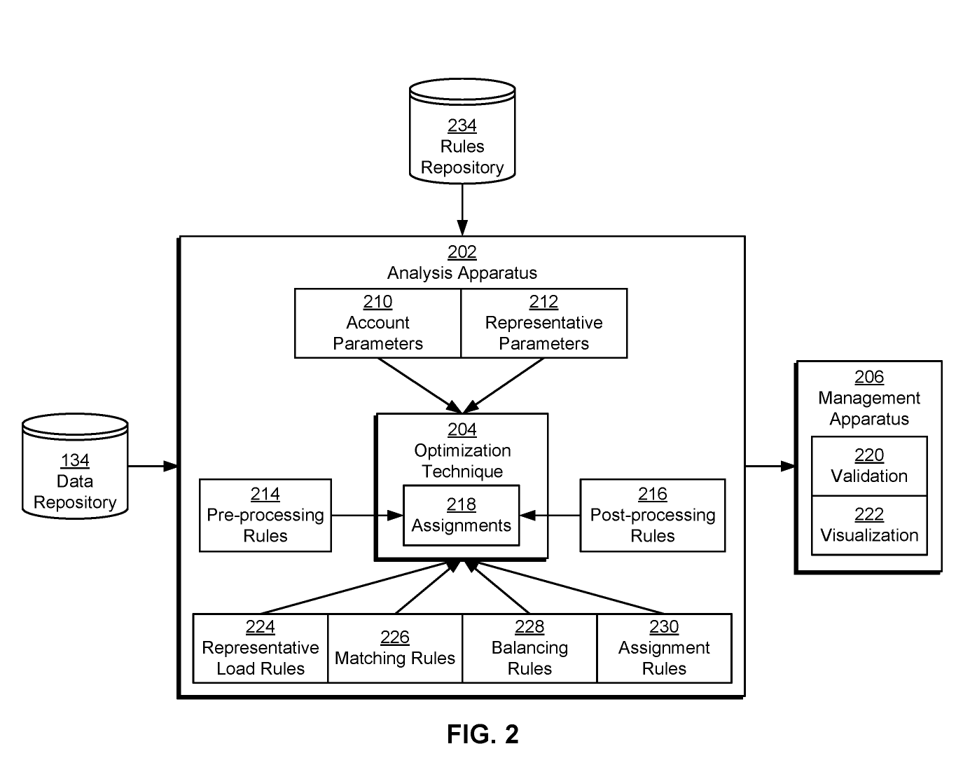

FIG. 2 shows a system for processing data in accordance with the disclosed embodiments. More specifically, FIG. 2 shows a system for generating assignments 218 of sales professionals to sales accounts, such as sales-management system 102 of FIG. 1. As shown in FIG. 2, the system includes an analysis apparatus 202 and a management apparatus 206. Each of these components is described in further detail below.

Analysis apparatus 202 may obtain a set of account parameters 210 and a set of representative parameters 212 from data repository 134. Account parameters 210 may include attributes of the sales accounts. For example, account parameters 210 may include an identifier, account name, industry, location (e.g., country, region, city, state, etc.), potential spending (e.g., maximum future spending), renewal target amount (i.e., a target dollar amount for an account's next renewal with a product), churn risk (i.e., the likelihood of fully or partially churning from the product), number of employees, and/or number of members in an online professional network (e.g., online professional network 118 of FIG. 1). Account parameters 210 may also include an account type of an account (e.g., relationship management, account executive, etc.), an account vertical (e.g., corporate, staffing, etc.), and/or an account level that reflects an account's historic spending, potential spending, and/or growth in spending. Account parameters 210 may further include a marketing segment of the account (e.g., fast growth, slow growth, small business, enterprise, high-volume, low-volume, high-budget, low-budget, high-churn, low-churn, etc.) for targeting and/or prioritizing by marketing professionals. Finally, account parameters 210 may include a pricing tier of the account for a given product or solution.

Representative parameters 212 may include attributes of the sales professionals. For example, representative parameters 212 may include an identifier, sales professional name, business unit, account load (i.e., a maximum number of accounts a sales professional can be assigned), minimum account load (i.e., a minimum number of accounts a sales professional is required to be assigned), industry, location, sales target, revenue target, account type, account vertical, and/or representative level (e.g., as matched to account level) for a given sales professional. Account parameters 210 and/or representative parameters 212 may further include social proximity scores that represent the strength of connections between sales professionals and accounts, as described in a co-pending non-provisional application by inventors John Chao, Liangie Hue, Huan Hoang, Wenjing Zhang, Michael Miller, Josh VanGeest and Qiang Zhu, entitled “Assigning Target Entities to Members of a Group Based on Social Proximity,” having Ser. No. 14/722,150, and filing date 27 May 2015 (Attorney Docket No. 60352-0079), which is incorporated herein by reference.

Analysis apparatus 202 may also obtain one or more sets of rules from a rules repository 234. Each set of rules may be used to optimize assignments 218 of a set of accounts to a group of sales professionals. For example, each set of rules in rules repository 234 may be associated with a different account type, account vertical, sales professional type, product (e.g., advertising solution, marketing solution, recruiting solution, sales solution, etc.), and/or location. The set of rules may additionally be linked to or provided with a set of account parameters 210 for accounts associated with the rules and a set of representative parameters 212 for sales professionals associated with the rules. In other words, different sets of rules in rules repository 234 may be provided by sales-operations and/or sales-management entities to customize the assignment of different groups of sales professionals to different sets of accounts.

Next, analysis apparatus 202 may apply an optimization technique 204 to each set of rules in rules repository 234 and the corresponding account parameters 210 and representative parameters 212 to produce a set of assignments 218 for the corresponding accounts and sales professionals. Each rule may identify one or more account parameters 210 and/or representative parameters 212 and specify one or more formulas and/or constraints to be applied to the identified parameters. As shown in FIG. 2, the rules may include pre-processing rules 214, post-processing rules 216, representative load rules 224, matching rules 226, balancing rules 228, and/or assignment rules 230.

Pre-processing rules 214 may be used to pre-process account parameters 210 and/or representative parameters 212 before optimization technique 204 is applied. In particular, pre-processing rules 214 may be used to update account parameters 210 and/or representative parameters 212 before other rules are used by optimization technique 204 to generate assignments 218. For example, one or more pre-processing rules may be used to calculate account levels for a set of accounts, with each account level representing a previous spending, current spending, change in spending, potential spending (e.g., over the lifetime of the account), and percentage of potential spending associated with an account. In another example, one or more pre-processing rules may be used to modify a set of regions associated with the sales professionals and/or accounts so that some of the regions are interchangeable. In a third example, one or more pre-processing rules may be used to calculate the potential spending and/or number of online professional network members associated with a given account. The calculated and/or modified values may then be used with other account parameters 210 and representative parameters 212 by subsequent rules to specify constraints associated with assigning accounts to sales professionals, as discussed below.

Pre-processing rules 214 may also be used to generate a subset of assignments 218 before optimization technique 204 is applied to other rules associated with the same set of sales professionals and accounts. For example, pre-processing rules 214 may include a default assignment of a given type of account to a sales professional with a certain identifier.

Pre-processing rules 214 may further be used to rank and/or prioritize the corresponding accounts and/or sales professionals by one or more metrics for subsequent use by optimization technique 204. For example, a pre-processing rule may specify the prioritization of existing or experienced sales professionals over new or inexperienced sales professionals during assigning of accounts to the sales professionals by optimization technique 204. Another pre-processing rule may rank the accounts in descending order of potential spending so that accounts with higher potential spending are assigned by optimization technique 204 before accounts with lower potential spending. The two pre-processing rules may be combined so that experienced sales professionals are generally assigned accounts with higher potential spending, which may improve customer retention, revenue, and/or sales growth associated with the accounts. Consequently, ranking of accounts and/or sales professionals using pre-processing rules 214 may both reduce the search space of optimization technique 204 and improve the performance of the optimization technique.

Representative load rules 224 may include upper and/or lower limits on the workload of the corresponding sales professionals. Representative load rules 224 may identify representative parameters 212 containing the minimum and/or maximum number of accounts that can be assigned to a set of sales professionals. Each representative load rule may optionally include one or more representative parameters 212 that define a group of sales professionals (e.g., account type, representative level, etc.) to which the representative load rule pertains and/or a formula for calculating the minimum or maximum workload of the group. For example, a representative load rule may calculate the maximum workload of a given level of sales professional as a percentage of the maximum workload of a different level of sales professional.

Matching rules 226 may match attributes of the sales professionals with attributes of the accounts. For example, matching rules 226 may require that the industry, account level, and/or location of an account matches the corresponding industry, representative level, and/or location of the sales professional to which the account is assigned.

Balancing rules 228 may specify an objective function for optimization technique 204 during assignment of the corresponding accounts to the corresponding sales professionals. Each balancing rule may include a balancing goal, one or more balancing parameters, and/or a variance. The balancing goal may include one or more metrics by which assignments 218 are to be balanced, the balancing parameters may include account and/or representative parameters for which the balancing is to be performed, and the variance may specify the amount by which the balancing goal may vary across the assignments. For example, a first balancing rule may include a balancing goal of potential spending, balancing parameters of account industry and representative country, and a variance of 10%. Thus, the first balancing rule may distribute, with a difference up to 10%, the potential spending of a set of accounts from the same industry across sales professionals from the same country. A second balancing rule may include a balancing goal of a number of accounts, balancing parameters of account industry and representative industry, and a variance of 15%. As a result, the second balancing rule may specify that sales professionals in the same industry are assigned the same number of accounts in that industry, with up to a 15% difference.

Assignment rules 230 may include manual assignments of sales professionals to accounts. For example, an assignment rule may specify a first identifier for a sales professional, a second identifier for an account, and a manual assignment of the account to the sales professional. In another example, an assignment rule may specify that accounts with preexisting opportunities be assigned to sales professionals who have handled the opportunities. The assignment rules may optionally override other constraints in the same set of rules. For example, an assignment rule may be applied even if it would violate a matching rule and/or balancing rule in the same set of rules.

After a set of rules from rules repository 234 and the corresponding account parameters 210 and representative parameters 212 from data repository 134 are provided to optimization technique 204, the optimization technique may generate a set of assignments 218 according to the rules. For example, the optimization technique may use a branch and bound method to obtain an optimal set of assignments 218 based on the objective function and the constraints specified in the rules. During an exemplary execution of the optimization technique, assignment rules 230 may first be applied to assign specific sales professionals to specific accounts. Next, dynamic matching of additional accounts to the sales professionals may be performed in a way that adheres to matching rules 226. The assignments may then be refined based on balancing rules 228, representative load rules 226, and/or other rules.

In addition, the operation and/or performance of optimization technique 204 may be improved using a number of techniques. As described above, one or more pre-processing rules 214 from a given set of rules may be used to rank and/or prioritize the corresponding accounts and/or sales professionals by one or more account parameters 210 and/or representative parameters 212. For example, the pre-processing rules may be used to order the accounts and/or sales representatives in decreasing order of potential spending, social proximity score, number of online professional network members per account, and/or other metrics associated with the objective function of optimization technique 204. In turn, optimization technique 204 may use the ordered data to generate assignments of higher-ranked or higher-priority accounts and/or sales professionals before assignments of lower-ranked or lower-priority accounts and/or sales professionals, while balancing the metrics across the assignments according to balancing rules 228.

Similarly, rules in rules repository 234 may be associated with different priorities, such that rules with higher priority take precedence over rules with lower priority. For example, a set of rules from rules repository 234 may be assigned three different priorities of low, medium, and high. Optimization technique 204 may select, from multiple sets of candidate assignments, a set of assignments 218 that satisfy all of the high-priority rules, as many of the medium-priority rules as possible, and one or more of the low-priority rules.

After the execution of optimization technique 204 has completed, analysis apparatus 202 may use one or more post-processing rules 216 to generate assignments of any remaining unassigned accounts to sales professionals. For example, analysis apparatus may obtain an identifier for a sales professional from a post-processing rule and assign all remaining unassigned accounts to the sales professional.

After assignments 218 are produced by analysis apparatus 202 and optimization technique 204, management apparatus 206 may provide a validation 220 of the assignments. For example, management apparatus 206 may output account parameters 210, representative parameters 212, and assignments 218 produced from the parameters. In turn, sales operations and/or sales management entities may analyze the outputted data to verify that the assignments conform to the corresponding set of rules from rules repository 234. Alternatively, management apparatus 206 may analyze the parameters and assignments to automatically verify that the assignments follow the constraints specified in the rules.

Management apparatus 206 may also provide a visualization 222 of the assignments for use in managing sales activity of the sales professionals. For example, management apparatus 206 may provide a user interface that allows the entities to view, modify, and/or confirm the assignments. In another example, management apparatus 206 may materialize the assignments in a customer relationship management (CRM) and/or sales-management platform. In turn, the sales professionals may conduct marketing or sales activities with the corresponding assigned accounts.

By applying optimization technique 204 to multiple sets of configurable rules, the system of FIG. 2 may automatically generate optimal sets of assignments 218 of sales professionals, thereby improving and/or automating one or more aspects of sales operations and/or sales management processes. The ranking and/or prioritization of the rules, accounts, and/or sales professionals prior to applying optimization technique 204 may further reduce the computational overhead of the optimization technique and ensure that important sales-related goals are reflected in the assignments.

Those skilled in the art will appreciate that the system of FIG. 2 may be implemented in a variety of ways. First, analysis apparatus 202, management apparatus 206, data repository 134, and/or rules repository 234 may be provided by a single physical machine, multiple computer systems, one or more virtual machines, a grid, one or more databases, one or more filesystems, and/or a cloud computing system. Analysis apparatus 202 and management apparatus 206 may additionally be implemented together and/or separately by one or more hardware and/or software components and/or layers.

Second, data may be created, stored, produced, and/or used by the system of FIG. 2 in a number of formats. For example, account parameters 210, representative parameters 212, pre-processing rules 214, post-processing rules 216, representative load rules 224, matching rules 226, balancing rules 228, and/or assignment rules 230 may be obtained from database records, spreadsheets, Extensible Markup language (XML) documents, JavaScript Object Notation (JSON) objects, property lists, source code, and/or executables. Similarly, assignments 218 may be outputted or stored in spreadsheet files, databases, and/or other file or data formats.

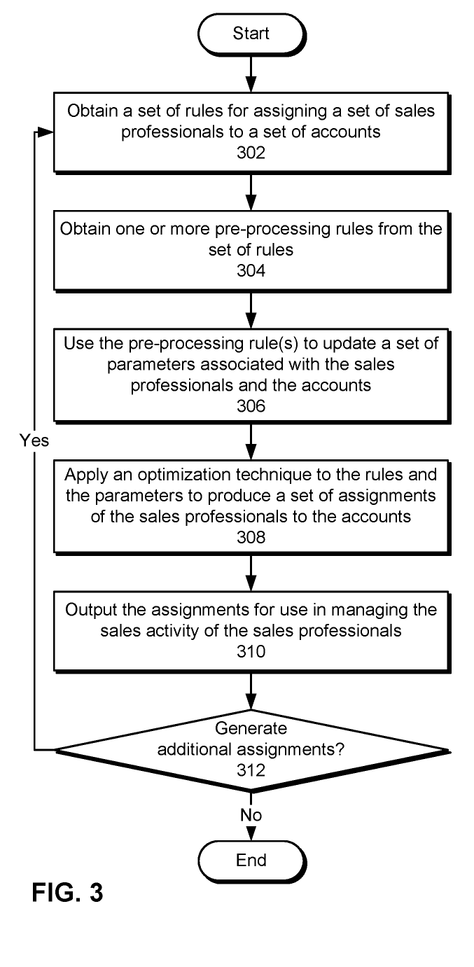

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of rules for assigning a set of sales professionals to a set of accounts is obtained (operation 302). The rules may include representative load rules that specify minimum and/or maximum account loads for the sales professionals, matching rules that match attributes of the sales professionals to attributes of the accounts, and/or assignment rules that assign sales professionals to accounts. The rules may also include balancing rules that include balancing goals, balancing parameters, and/or variances for optimizing the assignment of the sales professionals to the account. The rules may further include pre-processing rules that are applied before optimization of the assignments and post-processing rules that are applied after optimization of the assignments.

Next, one or more of the pre-processing rules are obtained from the set of rules (operation 304) and used to update a set of parameters associated with the sales professionals and accounts (operation 306). For example, the pre-processing rule(s) may be used to generate and/or modify account levels, regions, potential spending, and/or other attributes of the sales professionals and/or accounts. The pre-processing rules may also be used to rank and/or prioritize the sales professionals and/or accounts by one or more metrics such as potential spending, number of employees, number of online professional network members, and/or social proximity score.

An optimization technique is then applied to the rules and the parameters to produce a set of assignments of the sales professionals to the accounts (operation 308). For example, a branch and bound method may be used to obtain an optimal set of assignments of the sales professionals to the accounts based on the parameters, rankings, and/or an objective function and/or constraints specified in the rules. If the optimization technique fails to assign one or more accounts, one or more post-processing rules from the set of rules may be used to manually assign the remaining unassigned accounts to one or more sales professionals.

Finally, the assignments are outputted for use in managing the sales activity of the sales professionals (operation 310). For example, the assignments and parameters may be displayed and/or stored in a file or database for subsequent validation and use by sales-operations and/or sales-management entities. The assignments may also be exported to and/or materialized in a CRM and/or sales-management platform.

Additional assignments may be generated (operation 312) for other groups of sales professionals and/or accounts. For example, separate sets of assignments may be generated for sales professionals and/or accounts associated with different account types, account verticals, sales professional types, products, and/or locations. For each additional set of assignments to be generated, a set of rules for assigning sales professionals to accounts is obtained (operation 302), and one or more pre-processing rules from the set of rules are used to update parameters associated with the sales professionals and/or accounts (operations 304-306). An optimization technique is then used to produce the assignments (operation 308), and the assignments are outputted for use in managing the sales activity of the corresponding sales professionals (operation 310). Assignments of sales professionals to accounts may thus continue to be generated until all accounts associated with a given sales-operation and/or sales-management entity have been assigned to sales professionals.

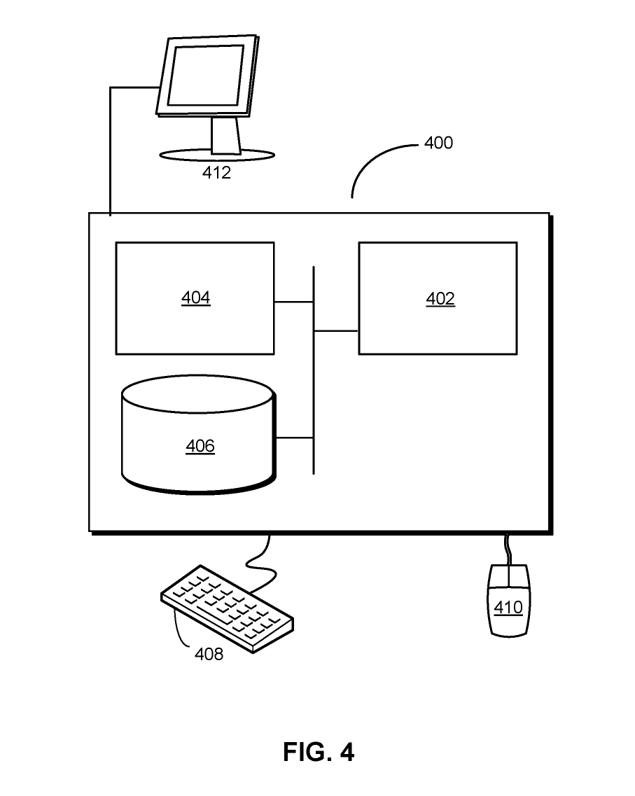

FIG. 4 shows a computer system 400. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system may include an analysis apparatus that obtains a set of rules for assigning a set of sales professionals to a set of accounts.

Next, the analysis apparatus may apply an optimization technique to the rules and a set of parameters associated with the sales professionals and the accounts to produce a set of assignments of the sales professionals to the accounts. The system may also include a management apparatus that outputs the assignments for using in managing sales activity of the sales professionals.

In addition, one or more components of computer system 400 may be remotely located and connected to the other components over a network. Portions of the present embodiments (e.g., analysis apparatus, management apparatus, data repository, rules repository, etc.) may also be located on different nodes of a distributed system that implements the embodiments. For example, the present embodiments may be implemented using a cloud computing system that generates assignments of sales professionals to accounts associated with a set of remote customers.

By configuring privacy controls or settings as they desire, members of social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a first set of rules for assigning a first set of sales professionals to a first set of accounts, wherein the first set of rules comprises a matching rule and a balancing rule;
applying, by a computer system, an optimization technique to the first set of rules and a first set of parameters associated with the first set of sales professionals and the first set of accounts to produce a first set of assignments of the first set of sales professionals to the first set of accounts; and
outputting the first set of assignments for using in managing sales activity of the first set of sales professionals.

2. The method of claim 1, further comprising:
obtaining a pre-processing rule from the first set of rules; and
using the pre-processing rule to update the first set of parameters prior to applying the optimization technique to the first set of rules and the first set of parameters.

3. The method of claim 4, wherein:
using the pre-processing rule to update the first set of parameters comprises ranking the first set of accounts or the first set of sales professionals by one or more metrics associated with the first set of rules; and
applying the optimization technique to the first set of rules and the first set of parameters to produce the first set of assignments comprises using the ranking and the first set of rules to assign the first set of sales professionals to the first set of accounts.

4. The method of claim 1, wherein the balancing rule comprises:
a balancing goal;
a balancing parameter; and
a variance.

5. The method of claim 4, wherein the matching rule comprises an account parameter associated with the first set of accounts and a representative parameter associated with the first set of sales professionals that matches the account parameter.

6. The method of claim 1, further comprising:
obtaining a second set of rules for assigning a second set of sales professionals to a second set of accounts;
applying the optimization technique to the second set of rules and a second set of parameters associated with the second set of sales professionals and the second set of accounts to produce a second set of assignments of the second set of sales professionals to the second set of accounts; and
outputting the second set of assignments.

7. The method of claim 6, wherein the first and second sets of rules are associated with at least one of:
different account types;
different account verticals;
different sales professional types;
different products; and
different locations.

8. The method of claim 1, wherein the first set of parameters associated with the first set of sales professionals comprises at least one of:
an account load;
a minimum account load;
an industry;
a location;
a social proximity score; and
a representative level.

9. The method of claim 1, wherein the first set of parameters associated with the first set of accounts comprises at least one of:
an industry;
a location;
a potential spending;
an account level;
a marketing segment; and
a pricing segment.

10. The method of claim 1, wherein the first set of rules further comprises an assignment rule and a representative load rule.

11. An apparatus, comprising:
one or more processors; and
memory storing instructions that, when executed by the one or more processors, cause the apparatus to:
obtain a first set of rules for assigning a first set of sales professionals to a first set of accounts, wherein the first set of rules comprises a matching rule, a balancing rule, an assignment rule, and a representative load rule;
apply an optimization technique to the first set of rules and a first set of parameters associated with the first set of sales professionals and the first set of accounts to produce a first set of assignments of the first set of sales professionals to the first set of accounts; and
output the first set of assignments for using in managing sales activity of the first set of sales professionals.

12. The apparatus of claim 11, wherein applying the optimization technique to the first set of rules and the first set of parameters to produce the first set of assignments of the first set of sales professionals to the first set of accounts comprises:
ranking the first set of accounts or the first set of sales professionals by one or more metrics associated with the first set of rules; and
using the ranking and the first set of rules to assign the first set of sales professionals and the first set of accounts.

13. The apparatus of claim 11, wherein the balancing rule comprises:
a balancing goal;
a balancing parameter; and
a variance.

14. The apparatus of claim 13, wherein the matching rule comprises an account parameter associated with the first set of accounts and a representative parameter associated with the first set of sales professionals that matches the account parameter.

15. The apparatus of claim 11, wherein the memory further stores instructions that, when executed by the one or more processors, cause the apparatus to:
obtain a second set of rules for assigning a second set of sales professionals to a second set of accounts;
apply the optimization technique to the second set of rules and a second set of parameters associated with the second set of sales professionals and the second set of accounts to produce a second set of assignments of the second set of sales professionals to the second set of accounts; and
output the second set of assignments.

16. The apparatus of claim 15, wherein the first and second sets of rules are associated with at least one of:
different account types;
different account verticals;
different sales professional types;
different products; and
different locations.

17. The apparatus of claim 11, wherein the first set of parameters associated with the first set of sales professionals comprises at least one of:
an account load;
a minimum account load;
an industry;
a location;
a social proximity score; and
a representative level.

18. The apparatus of claim 11, wherein the first set of parameters associated with the first set of accounts comprises at least one of:
an industry;
a location;
a potential spending;
an account level;
a marketing segment; and
a pricing segment.

19. A system, comprising:
an analysis module comprising a non-transitory computer-readable medium comprising instructions that, when executed, cause the system to:
obtain a first set of rules for assigning a first set of sales professionals to a first set of accounts, wherein the first set of rules comprises a representative load rule, a matching rule, and a balancing rule; and
apply an optimization technique to the first set of rules and a first set of parameters associated with the first set of sales professionals and the first set of accounts to produce a first set of assignments of the first set of sales professionals to the first set of accounts; and
a management module comprising a non-transitory computer-readable medium comprising instructions that, when executed, cause the system to output the first set of assignments for using in managing sales activity of the first set of sales professionals.

20. The system of claim 19, wherein applying the optimization technique to the first set of rules and the first set of parameters to produce the first set of assignments of the first set of sales professionals to the first set of accounts comprises:
ranking the first set of accounts or the first set of sales professionals by one or more metrics associated with the first set of rules; and
using the ranking and the first set of rules to assign the first set of sales professionals and the first set of accounts.
